(19) United States
(12) Patent Application Publication
(10) Pub. No.: US 2016/0110360 A1
(43) Pub. Date: Apr. 21, 2016

(54) PROVIDING NUMERICAL ANSWERS TO QUERIES

(71) Applicant: John J. Lee, Long Island City, NY (US)

(72) Inventor: John J. Lee, Long Island City, NY (US)

(73) Assignee: GOOGLE INC.

(21) Appl. No.: 13/759,968

(22) Filed: Feb. 5, 2013

Related U.S. Application Data
(60) Provisional application No. 61/654,441, filed on Jun. 1, 2012.
(60) Provisional application No. 61/654,518, filed on Jun. 1, 2012.

(51) Int. Cl. G06F 17/30

(52) U.S. Cl. CPC G06F 17/3053

(57) ABSTRACT

Methods, systems, and apparatus, including computer programs encoded on computer storage media, for providing numerical answers to queries. One of the methods includes identifying one or more text portions each corresponding to a numerical sentence or sentence fragment in text associated with search results that are responsive to a query. A text score is determined for each text portion based on one or more criteria. Text portions are grouped by a number included in each text portion. A group score is determined for each group based on respective scores of text portions in the group. A particular text portion is selected based on group scores of each group. A response is provided in response to the query that includes a number from the particular text portion.

### CROSS-REFERENCE TO RELATED APPLICATIONS

This application claims the benefit under 35 U.S.C. §119(e) of the filing date of U.S. Provisional Patent Application No. 61/654,441, filed on Jun. 1, 2012, entitled “Providing Numerical Answers to Questions.” This application also claims the benefit under 35 U.S.C. §119(e) of the filing date of U.S. Provisional Patent Application No. 61/654,518, filed on Jun. 1, 2012, entitled “General Purpose Question and Answer Handling System.” The entirety of the foregoing applications is herein incorporated by reference.

### BACKGROUND

User devices, such as mobile telephones, implement a variety of techniques through which users can find information. For example, some user devices implement dialog systems, which may be able to audibly provide answers to questions provided by users. The answers to some questions may include a number, such as a quantity. The question “How many books did Orson Scott Card write?” may be an example of such a question, since the answer to the question may include a number, which identifies how many books have been written by the author Orson Scott Card.

### SUMMARY

According to some implementations, a method may include identifying a set of search results based on a query; extracting a set of sentences from the identified set of search results; and identifying one or more numerical sentences, in the set of sentences. The one or more numerical sentences may each include at least one number. The method may further include generating a score for each of the one or more numerical sentences; and forming one or more clusters. The one or more clusters may each include at least one of the one or more numerical sentences, and the clusters may each be based on numbers included in the numerical sentences. The method may further include generating, based on the scores for the numerical sentences, a score for each of the formed clusters; selecting a particular numerical sentence based on: the generated scores for the one or more numerical sentences, and the generated scores for the formed one or more clusters; and outputting the selected numerical sentence.

According to some implementations, assuming that the particular numerical sentence is a first numerical sentence, the method may further include generating a sentence confidence score for a second numerical sentence, of the one or more numerical sentences, the sentence confidence score indicating a likelihood that the second numerical sentence is a full sentence or a sentence fragment. Generating a particular score for the second numerical sentence may include generating the particular score based on the sentence confidence score for the second numerical sentence.

According to some implementations, assuming that the particular numerical sentence is a first numerical sentence, generating a particular score for second numerical sentence, of the one or more numerical sentences, may include generating the particular score based on a quantity or ratio of terms of the second numerical sentence that are terms of the query.

According to some implementations, assuming that the particular numerical sentence is a first numerical sentence, generating a particular score for second numerical sentence, of the one or more numerical sentences, may include generating the particular score based on punctuation that ends the second numerical sentence.

According to some implementations, assuming that the particular numerical sentence is a first numerical sentence, generating a particular score for second numerical sentence, of the one or more numerical sentences, may include generating the particular score based on whether a particular number of the second numerical sentence is represented alphabetically or numerically.

According to some implementations, assuming that the particular numerical sentence is a first numerical sentence, generating a particular score for second numerical sentence, of the one or more numerical sentences, may include identifying a score associated with a particular search result, of the identified set of search results, from which the second numerical sentence was extracted; and generating the particular score based on the score associated with the particular search result.

According to some implementations, assuming that the particular numerical sentence is a first numerical sentence, generating a particular score for second numerical sentence, of the one or more numerical sentences, may include generating the particular score based on at least two of a quantity or ratio of terms of the second numerical sentence that are terms of the query, punctuation that ends the second numerical sentence, whether a particular number of the second numerical sentence is represented alphabetically or numerically, or a score associated with a particular search result, of the identified set of search results, from which the second numerical sentence was extracted.

The above discussion mentions examples in which some implementations may be implemented via one or more methods. In some implementations, one or more systems and/or devices may be configured to perform one or more of the acts mentioned above. In some implementations, a computer-readable medium may include computer-executable instructions which, when executed by one or more processors, cause the one or more processors to perform one or more of the acts mentioned above.

By selecting a numerical answer that may be a strong answer to a particular query, a system, according to one or more implementations, may enhance a user's experience.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIGS. 1A-1C illustrate an overview of example implementations described herein;

FIG. 2 illustrates an example environment in which systems and/or methods described herein may be implemented;

FIG. 3 illustrates an example of a generic computer device and a generic mobile computer device according to one or more implementations described herein;

FIG. 4 illustrates example functional components of a numerical answer system according to one or more implementations described herein;

FIG. 5 illustrates a flowchart of an example process for providing a numerical sentence as an answer to a query, according to one or more implementations described herein;

FIG. 6 illustrates a flowchart of an example process for generating a score for a particular numerical sentence, according to one or more implementations described herein; and

FIGS. 7A-7G illustrate examples of providing a numerical sentence as an answer to a query, according to one or more implementations described herein.

### DETAILED DESCRIPTION

The following detailed description refers to the accompanying drawings. The same reference numbers in different drawings may identify the same or similar elements.

A system and/or method, described herein, may enable one or more devices to provide answers to queries provided by users. The one or more devices may identify numerical answers—that is, answers that include numbers—that may be related to the queries.

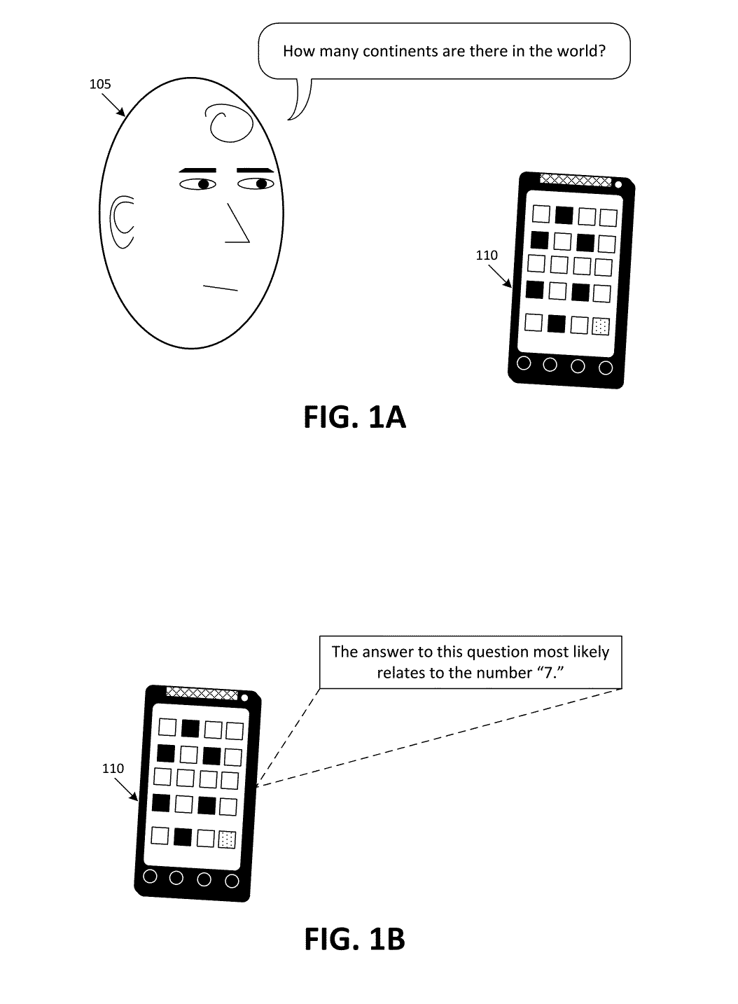

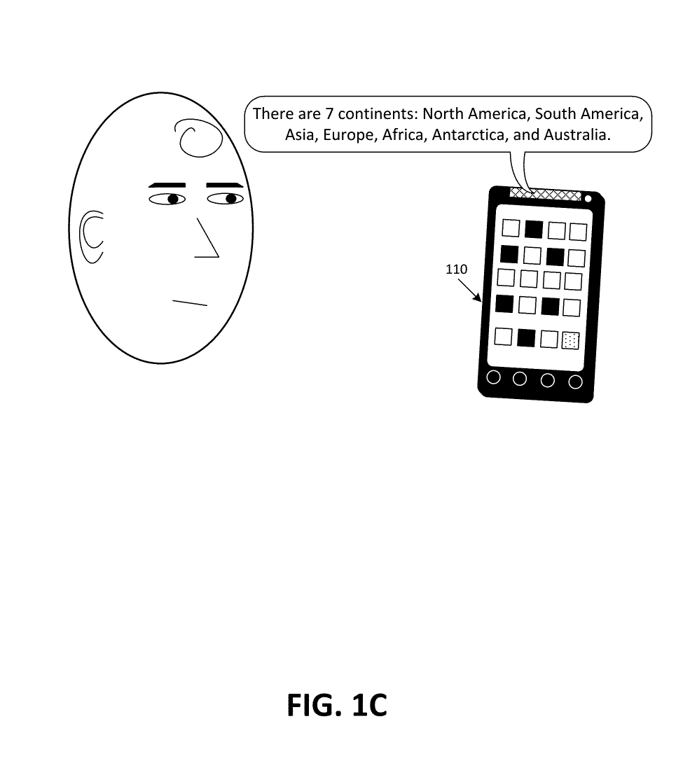

FIGS. 1A-1C illustrate an overview of example implementations described herein. As shown in FIG. 1A, user 105 may provide the query “How many continents are there in the world?” to user device 110. As shown in FIG. 1B, and as further described in more detail below, user device 110 may identify that an answer to the query may relate to the number “7”, i.e., the quantity of continents that exist in the world. As shown in FIG. 1C, user device 110 may output an answer, that includes the number “7,” to the query. For example, as shown in FIG. 1C, user device 110 may output the answer “There are 7 continents: North America, South America, Asia, Europe, Africa, Antarctica, and Australia.”

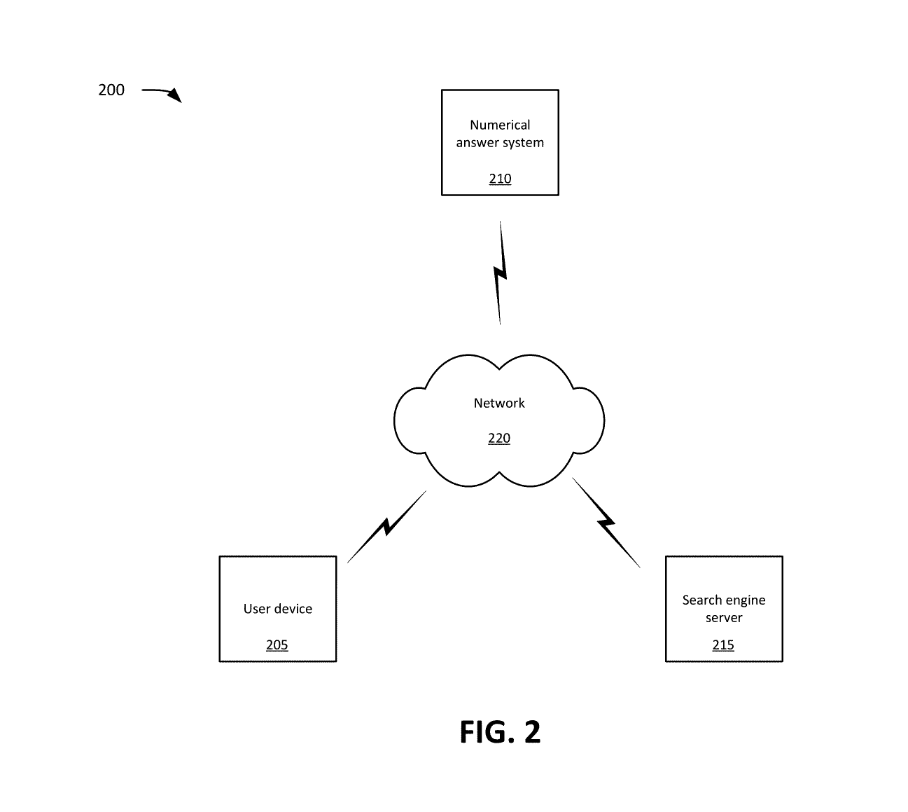

FIG. 2 is a diagram of an example environment 200 in which systems and/or methods described herein may be implemented. Environment 200 may include user device 205, numerical answer system 210, and search engine server 215 connected to network 220. One user device 205 and two servers 210 and 215 have been illustrated as connected to network 220 for simplicity. In practice, environment 200 may include additional user devices and/or servers or fewer user devices and/or servers. Also, in some instances, a user device may perform a function of a server, or a server may perform a function of a user device.

User device 205 may implement one or more functions of user device 110. User device 205 may include a client device, such as a mobile telephone, a personal computer, a personal digital assistant (“PDA”), a tablet computer, a laptop, or any other type of computation or communication device. User device 205 may include audio input/output devices that allow a user to communicate with user device 205 via speech. For example, these audio input/output devices may include one or more microphones and/or one or more speakers. User device 205 may also include one or more visual input/output devices, such as one or more cameras and/or one or more display screens that are capable of presenting a user interface via which a user may interact.

Servers 210 and 215 may each be implemented as a single server device or a collection of server devices that may be co-located or remotely located. Additionally, or alternatively, servers 210 and 215 may be implemented together within a single, common server device or a single, common collection of server devices.

Numerical answer system 210 may provide one or more answers to user device 205 in response to received queries. For example, as further described below, numerical answer system 210 may provide answers that include numbers. In order to provide answers, numerical answer system 210 may include and/or communicate with one or more search engines that receive search queries, such as search engine server 215.

Search engine server 215 may implement a search engine that receives queries, e.g., from user device 205 and/or from numerical answer system 210. Search engine server 215 may provide one or more search results in response to the received queries. The search results may include information regarding one or more documents, such as a link to the one or more documents. A document may include, for example, a web site, a file, a combination of files, one or more files with embedded links to other files, a news group posting, a news article, a blog, a business listing, an electronic version of printed text, a web advertisement, an e-mail, etc. In the context of the Internet, a common document is a web page. Documents often include textual information and may include embedded information, such as meta information, images, hyperlinks, etc., and/or embedded instructions, such as Javascript, etc.

The search results may also include one or more snippets, e.g., text that is derived from text included in one or more documents. For example, a particular snippet may include a portion of text from a particular document. Search engine server 215 may identify the portion of text based on relevance of the text to a particular search query. For example, search engine server 215 may identify a portion of text, of a document, that includes terms that are more relevant to the search query than terms of other portions of text of the document. As mentioned above, numerical answer system 210 may use the search results, received from search engine server 215, when outputting an answer to a query.

Additional servers, implementing other functions, may also be implemented in environment 200. The additional servers may provide, for example, web content, payment services, shopping services, social networking services, etc.

Network 220 may include any type of network, such as a local area network (“LAN”), a wide area network (“WAN”), a telephone network, e.g., the Public Switched Telephone Network (“PSTN”) or a cellular network, an intranet, the Internet, or a combination of networks. User device 205, query-answer system 210, and/or search engine server 215 may connect to network 220 via wired and/or wireless connections. In other words, user device 205, query-answer system 210, and/or search engine server 215 may connect to network 220 via a wired connection, a wireless connection, or a combination of a wired connection and a wireless connection.

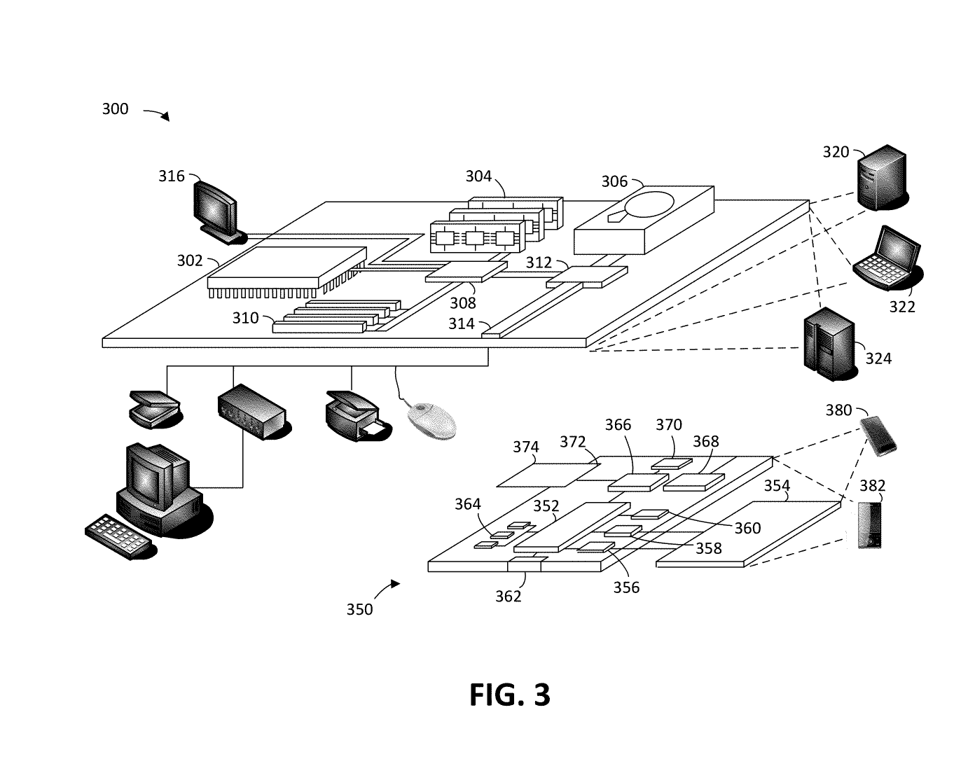

FIG. 3 shows an example of generic computing device 300 and generic mobile computing device 350, which may be used with the techniques described here. Computing device 300 and mobile computing device 350 may correspond to, for example, any of user device 205 and/or any of servers 210 or 215. Each of user device 205 and/or servers 210 and 215 may include one or more computing devices 300, mobile computing devices 350, or components of computing device 300 and/or mobile computing device 350.

Computing device 300 is intended to represent various forms of digital computers, such as laptops, desktops, workstations, personal digital assistants, servers, blade servers, mainframes, and other appropriate computers. Mobile computing device 350 is intended to represent various forms of mobile devices, such as personal digital assistants, cellular telephones, smart phones, and other similar computing devices. The components shown in FIG. 3, their connections and relationships, and their functions, are meant to be examples only, and are not meant to limit implementations described and/or claimed in this document.

Computing device 300 may include a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. Processor 302 can process instructions for execution within the computing device 300, including instructions stored in the memory 304 or on the storage device 306 to display graphical information for a graphical user interface (“GUI”) on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations, e.g., as a server bank, a group of blade servers, or a multi-processor system, etc.

Memory 304 stores information within the computing device 300. In some implementations, memory 304 includes a volatile memory unit or units. In some implementations, memory 304 includes a non-volatile memory unit or units. The memory 304 may also be another form of computer-readable medium, such as a magnetic or optical disk. A computer-readable medium may be defined as a non-transitory memory device. A memory device may include space within a single physical memory device or spread across multiple physical memory devices.

Storage device 306 is capable of providing mass storage for the computing device 300. In some implementations, storage device 306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 304, storage device 306, or memory on processor 302.

High speed controller 308 manages bandwidth-intensive operations for the computing device 300, while low speed controller 312 manages lower bandwidth-intensive operations. Such allocation of functions is exemplary only. In some implementations, high-speed controller 308 is coupled to memory 304, display 316, e.g., through a graphics processor or accelerator, and to high-speed expansion ports 310, which may accept various expansion cards (not shown). In this implementation, low-speed controller 312 is coupled to storage device 306 and low-speed expansion port 314. The low-speed expansion port, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

Computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as mobile computing device 350. Each of such devices may contain one or more of computing devices 300, 350, and an entire system may be made up of multiple computing devices 300, 350 communicating with each other.

Mobile computing device 350 may include a processor 352, memory 364, an input/output (“I/O”) device such as a display 354, a communication interface 366, and a transceiver 368, among other components. Mobile computing device 350 may also be provided with a storage device, such as a micro-drive or other device, to provide additional storage. Each of the components 350, 352, 364, 354, 366, and 368 are interconnected using various buses, and several of the components may be mounted on a common motherboard or in other manners as appropriate.

Processor 352 can execute instructions within mobile computing device 350, including instructions stored in memory 364. Processor 352 may be implemented as a chipset of chips that include separate and multiple analog and digital processors. Processor 352 may provide, for example, for coordination of the other components of mobile computing device 350, such as control of user interfaces, applications run by mobile computing device 350, and wireless communication by mobile computing device 350.

Processor 352 may communicate with a user through control interface 358 and display interface 356 coupled to a display 354. Display 354 may be, for example, a Thin-Film-Transistor Liquid Crystal Display (“TFT LCD”) or an Organic Light Emitting Diode (“OLED”) display, or other appropriate display technology. Display interface 356 may include appropriate circuitry for driving display 354 to present graphical and other information to a user. Control interface 358 may receive commands from a user and convert them for submission to the processor 352. In addition, an external interface 362 may be in communication with processor 352, so as to enable near area communication of mobile computing device 350 with other devices. External interface 362 may provide, for example, for wired communication in some implementations, or for wireless communication in other implementations, and multiple interfaces may also be used.

Memory 364 stores information within mobile computing device 350. Memory 364 can be implemented as one or more of a computer-readable medium or media, a volatile memory unit or units, or a non-volatile memory unit or units. Expansion memory 374 may also be provided and connected to mobile computing device 350 through expansion interface 372, which may include, for example, a Single In Line Memory Module (“SIMM”) card interface. Such expansion memory 374 may provide extra storage space for device 350, or may also store applications or other information for mobile computing device 350. Specifically, expansion memory 374 may include instructions to carry out or supplement the processes described above, and may include secure information also. Thus, for example, expansion memory 374 may be provide as a security module for mobile computing device 350, and may be programmed with instructions that permit secure use of device 350. In addition, secure applications may be provided via the SIMM cards, along with additional information, such as placing identifying information on the SIMM card in a non-hackable manner.

Expansion memory 374 may include, for example, flash memory and/or NVRAM memory. In some implementations, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352, that may be received, for example, over transceiver 368 or external interface 362.

Mobile computing device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver. In addition, Global Positioning System (“GPS”) receiver module 370 may provide additional navigation- and location-related wireless data to mobile computing device 350, which may be used as appropriate by applications running on mobile computing device 350.

Mobile computing device 350 may also communicate audibly using audio codec 360, which may receive spoken information from a user and convert it to usable digital information. Audio codec 360 may likewise generate audible sound for a user, such as through a speaker, e.g., in a handset of mobile computing device 350. Such sound may include sound from voice telephone calls, may include recorded sound, e.g., voice messages, music files, etc., and may also include sound generated by applications operating on mobile computing device 350.

Mobile computing device 350 may be implemented in a number of different forms, as shown in the figure. For example, it may be implemented as a cellular telephone 380. It may also be implemented as part of a smart phone 382, personal digital assistant, or other similar mobile device.

Various implementations of the systems and techniques described herein can be realized in digital electronic circuitry, integrated circuitry, specially designed application specific integrated circuits (“ASICs”), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” and “computer-readable medium” refer to any non-transitory apparatus and/or device, e.g., magnetic discs, optical disks, memory, Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device, e.g., a cathode ray tube (“CRT”) or liquid crystal display (“LCD”) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described herein can be implemented in a computing system that includes a back end component, e.g., as a data server, or that includes a middleware component, e.g., an application server, or that includes a front end component, e.g., a client computer having a graphical user interface or a Web browser through which a user can interact with implementations of the systems and techniques described here, or any combination of such back end, middleware, or front end components. The components of the system can be interconnected by any form or medium of digital data communication, e.g., a communication network. Examples of communication networks include a LAN, a WAN, and the Internet.

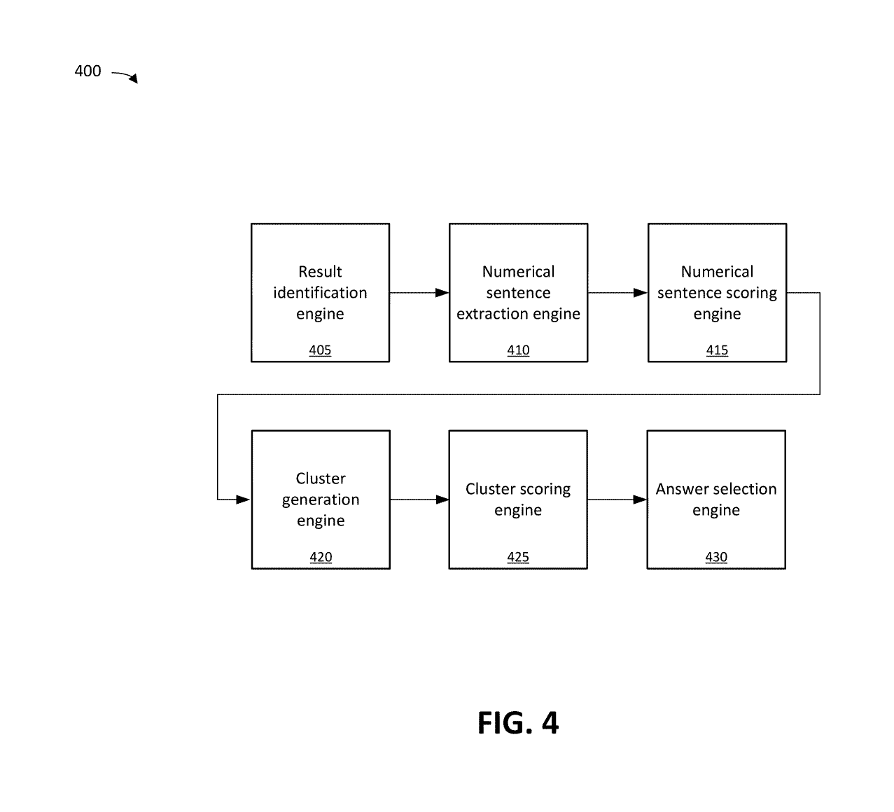

FIG. 4 illustrates example functional components of an example system 400. System 400 may correspond to, for instance, numerical answer system 210. As shown in FIG. 4, system 400 may include modules 405-430. In some implementations, system 400 may include fewer, additional, or different modules. Any, or all, of modules 405-430 may be implemented by one or more memory devices, such as memory 304 and/or memory 364, and/or one or more processors, such as processor 308 and/or processor 352. Furthermore, multiple modules may be associated with the same memory device and/or processor. For example, one memory device, or one set of memory devices, may store information associated with two or more of modules 405-430.

Result identification engine 405 may receive a query, and may identify search results associated with the query. Result identification engine 405 may receive a query from a user device, such as user device 205. In some implementations, result identification engine 405 may provide some or all of the query as a search query to a search engine, such as search engine server 215. Search engine server 215 may identify a set of search results that are responsive to the search query. As mentioned above, the search results may include information identifying a set of documents and/or a set of snippets, which may include text derived from the documents.

In some implementations, search engine server 215 may generate and/or identify scores and/or rankings associated with the search results. The scores and/or rankings may be based on a variety of factors. For example, a score for a particular document, when provided as a search result in response to a particular query, may be based on a relevance of the particular document to the query, a quantity of links to and/or from the document, a measure of freshness of the document, a document inception date associated with the document, an amount of advertising traffic associated with the document, and/or any other factor. The particular document may be ranked with regard to other documents in a set of documents based on this score and/or based on any other criteria.

Result identification engine 405 may receive the search results—that is, information identifying documents, snippets, and/or scores/rankings associated with the documents—from search engine server 215. Result identification engine 405 may provide some or all of the received search results to numerical sentence extraction engine 410. In some implementations, result identification engine 405 may provide only up to a particular maximum quantity of search results to numerical sentence extraction engine 410. For example, assume that the particular maximum quantity is 100, and result identification engine 405 receives 1,000 search results from search engine server 215. In this example, result identification engine 405 may provide only 100 of the 1,000 received search results—e.g., the highest-scoring 100 search results, the lowest-scoring 100 search results, any random 100 of the search results, etc.—to numerical sentence extraction engine 410. In some implementations, result identification engine 405 may provide all of the search results, received from search engine server 215, to numerical sentence extraction engine 410.

Numerical sentence extraction engine 410 may extract text portions that correspond to numerical sentences from the search results received from result identification engine 405. As used in this specification, a numerical sentence is a text portion that includes a full independent clause and a number. In other words, a numerical sentence can include less than all of a sentence and need not include ending punctuation. The numerical sentence extraction engine 410 can extract text portions from search result snippets that correspond to numerical sentences and assign scores to the text portions based on a variety of factors.

Numerical sentence extraction engine 410 may first analyze snippets associated with the received search results and extract text portions that potentially correspond to full independent clauses. Numerical sentence extraction engine 410 may identify multiple portions of a snippet that each potentially include an independent clause. For instance, in the sentence, “Billy is a boy, and he has a red cap,” numerical sentence extraction engine 410 may extract the text portion “Billy is a boy,” and numerical sentence extraction engine 410 may further extract the text portion “he has a red cap.” In order to extract text portions that potentially correspond to full independent clauses, numerical sentence extraction engine 410 may use syntactical analysis, semantic analysis, character analysis, and/or any other type of technique. For instance, numerical sentence extraction engine 410 may extract a text portion based on the presence of punctuation at the end of the text portion, such as a period, a question mark, an exclamation point, a comma, a semicolon, or the like. Additionally, or alternatively, numerical sentence extraction engine 410 may extract a text portion based on the presence of an indication of a beginning of a sentence or a clause, such as one or more capital letters.

For instance, assume that numerical sentence extraction engine 410 receives the snippet “Star Wars is one of the highest-grossing movies of all time, after adjusting for inflation, which is . . . . ” In some implementations, numerical sentence extraction engine 410 may extract the following text portion of the snippet: “Star Wars is one of the highest-grossing movies of all time, after adjusting for inflation”. Numerical sentence extraction engine 410 may omit—that is, forego extracting—the text portion of the snippet that does not potentially include a full independent clause, namely, “which is . . . . ”

In some implementations, numerical sentence extraction engine 410 may assign a sentence confidence score to the extracted text portions. The sentence confidence score for a particular sentence represents a likelihood that the particular text portion includes a full independent clause.

In order to assign a sentence confidence score, numerical sentence extraction engine 410 may use one or more of a variety of techniques. For example, numerical sentence extraction engine 410 may use semantic and/or syntactical analysis to determine whether a text portion includes a grammatically complete independent clause or a sentence fragment. Numerical sentence extraction engine 410 may, for example, determine whether the text portion includes a subject, a verb, and an object. Numerical sentence extraction engine 410 may determine that a text portion does not include a subject, a verb, or an object and in response may assign a sentence confidence score that reflects that the text portion may potentially be a sentence fragment. Similarly, numerical sentence extraction engine 410 may determine that a text portion includes a subject, a verb, and an object and in response may assign a sentence confidence score that reflects that the text portion may potentially be a full independent clause, e.g., a confidence score that is higher than a confidence score that reflects that a sentence may potentially be a sentence fragment.

In some implementations, numerical sentence extraction engine 410 may determine that extracted text portions that are associated with confidence scores that satisfy a threshold confidence score include full independent clauses, and that extracted text portions that are associated with confidence scores that do not satisfy a threshold confidence score are sentence fragments. In some implementations, text portions that are sentence fragments may be discarded. In other words, subsequent processing may be performed on text portions that are full independent clauses, and not on sentences that are sentence fragments, e.g., sentences that are not associated with confidence scores that satisfy a threshold confidence score.

While numerical sentence extraction engine 410 may extract text portions from snippets that are likely to include full independent clauses, descriptions and explanations are provided herein in the context of sentences. For example, when examples are given with respect to sentences that have been extracted by numerical sentence extraction engine 410, it should be understood that such examples may additionally, or alternatively, apply to independent clauses that have been extracted by numerical sentence extraction engine 410 that do not correspond to a full sentence in a text snippet. In some implementations, numerical sentence extraction engine 410 may only extract one sentence from one search result. In some implementations, numerical sentence extraction engine 410 may extract multiple sentences from a single search result.

Numerical sentence extraction engine 410 may further identify which of the extracted text portions include numbers. For example, numerical sentence extraction engine 410 may identify the occurrence of numerical characters, such as 0, 1, 2, 3, 4, 5, 6, 7, 8, and/or 9 in the extracted text portions. In some implementations, numerical sentence extraction engine 410 may identify the occurrence of alphabetically spelled numbers, such as “zero,” “one,” “twenty,” “five hundred,” etc., in the extracted text portions.

In some implementations, numerical sentence extraction engine 410 may identify that terms that include both numerical characters and alphabetic characters are not numbers. For example, numerical sentence extraction engine 410 may identify that the text portions “The AC-130 is a great airplane” and “I drive a Ferrari F355” are not numerical sentences because, while these sentences include numerical characters, these numerical characters are included in terms that also include alphabetic characters.

For example, assume that numerical sentence extraction engine 410 analyzes the following three text portions: “There are 50 states in the United States,” “I like eating fifty pizzas at once,” and “Turkey dinners are delicious.” In this example, numerical sentence extraction engine 410 may identify that the text portions “There are 50 states in the United States” and “I like eating fifty pizzas at once” are numerical sentences, while the text portion “Turkey dinners are delicious” is not a numerical sentence.

If an extracted text portion both includes a full independent clause and includes at least one number, the numerical sentence extraction engine 410 can designate the text portion as a numerical sentence. Numerical sentence extraction engine 410 can determine whether an extracted text portion includes numbers either before, after, or at the same time as determining that the extracted text portion includes an independent clause. Numerical sentence extraction engine 410 may then output the extracted numerical sentences to numerical sentence scoring engine 415.

Numerical sentence scoring engine 415 may generate or modify scores for the numerical sentences based on one or more of a variety of factors. One such factor may include a quantity of terms in a numerical sentence that are associated with terms of a query. Numerical sentence scoring engine 415 may identify, for example, a term in a numerical sentence that is identical to a term of a query; a term in a numerical sentence that is partially identical to a term of a query; a term in a numerical sentence that is semantically similar or identical to a term of a query, e.g., a synonym; a term in a numerical sentence that is a potential spell correction of a term of a query; and/or other any type of related term.

For example, assume that a received query includes the phrase “How many movies did Georje Lucas direct?”, and assume that a numerical sentence that was extracted from search results retrieved in response to the query includes the phrase “George Lucas directed 19 films.” Numerical sentence scoring engine 415 may identify that the term “Lucas” appears in the numerical sentence and in the query. Numerical sentence scoring engine 415 may identify that the term “directed,” in the numerical sentence, is partially identical to the term “direct,” in the query. Additionally, or alternatively, numerical sentence scoring engine 415 may identify that the term “directed,” in the numerical sentence, is semantically similar to the term “direct,” in the query. Additionally, or alternatively, numerical sentence scoring engine 415 may identify that the term “films,” in the numerical sentence, is semantically similar to the term “movies,” in the query. Additionally, or alternatively, numerical sentence scoring engine 415 may identify that the term “George,” in the numerical sentence, is a potential spell correction of the term “Georje,” in the query.

In some implementations, numerical sentence scoring engine 415 may ignore certain terms when identifying terms of numerical sentences that are associated with terms of queries. For example, numerical sentence scoring engine 415 may ignore stop words, e.g. “the,” “and,” “or,” “in,” “at,” “is,” “are,” “was,” or the like. In some implementations, numerical sentence scoring engine 415 may ignore terms that are associated with queries, e.g. “how,” “how many,” “who,” “which,” “what,” “where,” “when,” or the like. For example, assume that a particular query includes the phrase “How many computers are there in the world?” In some implementations, numerical sentence scoring engine 415 may omit the terms “how many,” “in,” and “the” when identifying terms of numerical sentences that are associated with terms of the query.

Numerical sentence scoring engine 415 may generate or modify a score for a numerical sentence based on identifying the terms in the numerical sentence that are related to terms in a query. For example, numerical sentence scoring engine 415 may generate or modify a score for a numerical sentence based on a quantity of terms of the numerical sentence that are terms of the query. Additionally, or alternatively, numerical sentence scoring engine 415 may generate or modify a score for the numerical sentence based on a ratio of terms of the numerical sentence to terms of the numerical sentence that are terms of the query, and/or based on any other ratio, e.g., a ratio of terms of the query to terms of the numerical sentence that are terms of the query, etc.

Another factor, based on which numerical sentence scoring engine 415 may generate or modify a score for a numerical sentence, may include a type of punctuation that ends the numerical sentence. For example, numerical sentence scoring engine 415 may identify whether a numerical sentence ends with a question mark. If a numerical sentence ends with a question mark, numerical sentence scoring engine 415 may generate a score for the numerical sentence that would be lower than the score for the numerical sentence if the numerical sentence did not have a question mark. For example, assume that numerical sentence scoring engine 415 analyzes the following two numerical sentences: “There go 300 Spartans?”, and “There go 300 Spartans.” Numerical sentence scoring engine 415 may generate a lower score for the former numerical sentence than for the latter numerical sentence, since the former numerical sentence ends with a question mark.

In some implementations, numerical sentence scoring engine 415 may modify an existing score based on whether a numerical sentence ends in a question mark. For example, assume that numerical sentence scoring engine 415 identifies that the above two numerical sentences are each associated with a particular score. Numerical sentence scoring engine 415 may modify the score for the numerical sentence ending in a question mark, e.g., by lowering the score, while foregoing modifying the score for the numerical sentence that does not end in a question mark, or modifying the score for the numerical sentence that does not end in a question mark differently, e.g., by raising the score, lowering the score by a different amount, etc.

Yet another factor, based on which numerical sentence scoring engine 415 may generate or modify a score for a numerical sentence, may include whether a number in a numerical sentence is represented with numerical characters or alphabetic characters. If a numerical sentence includes a number that is represented with alphabetic characters, numerical sentence scoring engine 415 may generate a score for the numerical sentence that would be lower than the score for the numerical sentence if the number were represented with numerical characters. For example, assume that numerical sentence scoring engine 415 analyzes the following two numerical sentences: “There go three hundred Spartans,” and “There go 300 hundred Spartans.” Numerical sentence scoring engine 415 may generate a lower score for the former numerical sentence than for the latter numerical sentence, since the number in the former numerical sentence is represented with alphabetic characters and the number in the latter numerical sentence is represented with numerical characters.

In some implementations, numerical sentence scoring engine 415 may modify an existing score based on whether a numerical sentence ends in a question mark. For example, assume that numerical sentence scoring engine 415 identifies that the above two numerical sentences are each associated with a particular score. Numerical sentence scoring engine 415 may modify the score for the former numerical sentence, e.g., by lowering the score, while foregoing modifying the score for the latter numerical sentence, or modifying the score for the latter numerical sentence differently, e.g., by raising the score, lowering the score by a different amount, etc.

Still another factor, based on which numerical sentence scoring engine 415 may generate or modify a score for a numerical sentence, may include whether a number in a numerical sentence is part of a date. If a numerical sentence includes a number that is part of a date, numerical sentence scoring engine 415 may generate a score for the numerical sentence that would be lower than the score for the numerical sentence if the number were not part of a date. For example, assume that numerical sentence scoring engine 415 analyzes the following two numerical sentences: “The Declaration of Independence was signed on Jul. 4, 1776,” and “The Declaration of Independence was signed by 56 people.” Numerical sentence scoring engine 415 may generate a lower score for the former numerical sentence than for the latter numerical sentence, since the number in the former numerical sentence is part of a date, and the number for the latter numerical sentence is not a date.

In some implementations, numerical sentence scoring engine 415 may modify an existing score based on whether a number in a numerical sentence is part of a date. For example, assume that numerical sentence scoring engine 415 identifies that the above two numerical sentences are each associated with a particular score. Numerical sentence scoring engine 415 may modify the score for the former numerical sentence, e.g., by lowering the score, while foregoing modifying the score for the latter numerical sentence, or modifying the score for the latter numerical sentence differently, e.g., by raising the score, lowering the score by a different amount, etc.

Another factor, based on which numerical sentence scoring engine 415 may generate or modify a score for a numerical sentence, may include a score or ranking associated with a search result from which the numerical sentence was extracted. For example, assume that numerical sentence scoring engine 415 analyzes two numerical sentences that were extracted from two different search results. Assume that a first one of these numerical sentences was extracted from a higher-ranked search result than a search result from which the second one of these numerical sentences was extracted. Numerical sentence scoring engine 415 may generate a higher score for the first numerical sentence than for the second numerical sentence, since the first numerical sentence was extracted from a higher-ranked search result.

In some implementations, numerical sentence scoring engine 415 may modify an existing score based on a score or ranking associated with a search result from which a numerical sentence was extracted. For example, assume that numerical sentence scoring engine 415 identifies that the above first and second numerical sentences are each associated with a particular score. Numerical sentence scoring engine 415 may modify the score for the second numerical sentence, e.g., by lowering the score, while foregoing modifying the score for the first numerical sentence, or modifying the score for the latter numerical sentence differently, e.g., by raising the score.

Yet another factor, based on which numerical sentence scoring engine 415 may generate or modify a score for a numerical sentence, may include whether a query associated with the numerical sentence is a number-triggering query. For example, assume that numerical sentence scoring engine 415 identifies that the query “How many storm troopers were shown in Star Wars Episode II?” has been received. Numerical sentence scoring engine 415 may identify that the query is a number-triggering query, and may generate or modify scores for numerical sentences extracted from search results that are responsive to the query based on identifying that the query is a number-triggering query. For example, numerical sentence scoring engine 415 may increase scores associated with numerical sentences extracted from search results that are responsive to the query, and/or may forego lowering scores associated with these numerical sentences.

As another example, assume that numerical sentence scoring engine 415 identifies that the query “Who is the president of America?” has been received. Numerical sentence scoring engine 415 may identify that the query is not a number-triggering query, and may generate or modify scores for numerical sentences extracted from search results that are responsive to the query based on identifying that the query is not a number-triggering query. For example, numerical sentence scoring engine 415 may lower scores associated with numerical sentences extracted from search results that are responsive to the query, and/or may forego increasing scores associated with these numerical sentences.

Numerical sentence scoring engine 415 may identify whether a query is a number-triggering query using a variety of techniques. For example, numerical sentence scoring engine 415 may determine whether the query includes terms from a list of terms associated with number triggering-queries, such as “how many,” “how much,” “what quantity,” or the like. Numerical sentence scoring engine 415 may use learning techniques over time to expand and/or refine the list of terms associated with number-triggering queries. For example, numerical sentence scoring engine 415 may identify over time that a particular phrase, that is not associated with the list of terms, is often associated with an answer that includes a number. Based on this identifying, numerical sentence scoring engine 415 may add the particular phrase to the list of terms.

Another factor, based on which numerical sentence scoring engine 415 may generate or modify a score for a numerical sentence, may include a sentence confidence score associated with the numerical sentence. For example, assume that numerical sentence scoring engine 415 receives the numerical sentences “A discussion of what constitutes the seven continents of the world” and “There are seven continents in the world.” The former numerical sentence may be associated with a lower sentence confidence score than the latter numerical sentence, since “A discussion of what constitutes the seven continents of the world” is a sentence fragment, and “There are seven continents in the world” is a full independent clause. Numerical sentence scoring engine 415 may generate a higher score for the latter numerical sentence than for the former numerical sentence, since the latter numerical sentence is a full independent clause, while the former numerical sentence is a sentence fragment.

In some implementations, numerical sentence scoring engine 415 may modify an existing score based on a sentence confidence score associated with a numerical sentence. For example, assume that numerical sentence scoring engine 415 identifies that the above former and latter numerical sentences are each associated with a particular score. Numerical sentence scoring engine 415 may modify the score for the former numerical sentence, e.g., by lowering the score, while foregoing modifying the score for the latter numerical sentence, or modifying the score for the former numerical sentence differently, e.g., by raising the score, lowering the score by a different amount, etc.

In some implementations, some numerical sentences may be associated with multiple scores. For example, numerical sentence scoring engine 415 may generate or modify multiple scores for numerical sentences with multiple numbers, e.g., one score per number in the numerical sentence. The multiple scores may be based on one or more factors that are common between the two scores, and one or more factors that are not common between the two scores. Assume, for instance, that a numerical sentence, associated with the query “How many people signed the Declaration of Independence?” includes the phrase “Fifty-six men signed the Declaration of Independence in July 1776.”

Numerical sentence scoring engine 415 may generate one score for the numerical sentence with respect to the number “fifty-six,” and another score for the numerical sentence with respect to the number “1776.” The first score may be based on the following factors: the number “fifty-six” is represented as alphabetic characters, the numerical sentence includes four terms that are terms of the query, and the numerical sentence does not end with a question mark. The second score may be based on the following factors: the number “1776” is part of a date, the numerical sentence includes four terms that are terms of the query, and the numerical sentence does not end with a question mark.

In some implementations, numerical sentence scoring engine 415 may generate or modify a single score for numerical sentences with multiple numbers. For example, referring to the above example numerical sentence, numerical sentence scoring engine 415 may generate or modify a score for the numerical sentence based on the following factors: the number “fifty-six” is represented as alphabetic characters, the number “1776” is part of a date, the numerical sentence includes four terms that are terms of the query, and the numerical sentence does not end with a question mark. Thus, in some implementations, a single factor or a combination of factors may be used to generate or modify a score. In some implementations, different factors may be weighted differently when generating or modifying a score.

Numerical sentence scoring engine 415 may output the numerical sentences, along with associated scores, to cluster generation engine 420. Cluster generation engine 420 may form or modify clusters based on the received numerical sentences. In some implementations, a particular cluster may be associated with a particular number. For example, assume that cluster generation engine 420 receives the following three numerical sentences: “There are five boroughs in New York City,” “NYC has 5 boroughs,” and “The Redskins have won 3 Super Bowls.” Cluster generation engine 420 may form or modify a cluster associated with the number “5.” This cluster may include the numerical sentences “There are five boroughs in New York City” and “NYC has 5 boroughs.” Cluster generation engine 420 may also form or modify a cluster associated with the number “3.” This cluster may include the numerical sentence “The Redskins have won 3 Super Bowls.”

In some scenarios, one numerical sentence may include multiple numbers. In some implementations, cluster generation engine 420 may associate such numerical sentences with multiple clusters. For example, assume that cluster generation engine 420 receives the numerical sentence “Neo beat up 3 agents in five minutes.” Cluster generation engine 420 may generate or modify a cluster associated with the number “3” to include the above numerical sentence, and may also generate or modify a cluster associated with the number “5” to include the above numerical sentence.

Further, in some implementations, as mentioned above, numerical sentences with multiple numbers may be associated with multiple scores. Continuing with the above example, the numerical sentence “Neo beat up 3 agents in five minutes” may be associated with one score S₁ with respect to the number “3,” and may be associated with another score S₂ with respect to the number “5.” When associating this numerical sentence with respective clusters, cluster generation engine 420 may store information associating the score S₁ and the numerical sentence with the cluster associated with the number “3” and information associating the score S₂ and the numerical sentence with the cluster associated with the number “5.”

While in some implementations, as described above, cluster generation engine 420 may generate clusters based on a single number, cluster generation engine 420 may, in some implementations, generate clusters based on ranges of numbers. For example, in some such implementations, cluster generation engine 420 may generate a cluster that is associated with the range “10-15,” a cluster that is associated with the range “16-20,” a cluster that is associated with the range “21-23,” etc. In this example, the numerical sentences “Ten seconds elapsed before Greedo shot Han” and “Lieutenant Commander Data is 11 years old” may be associated with the cluster that is associated with the range “10-15.”

Cluster generation engine 420 may output the clusters and the scores associated with the numerical sentences to cluster scoring engine 425. Cluster scoring engine 425 may generate scores for the clusters based on, for example, the scores associated with the numerical sentences in the clusters. Assume, for example, that a particular cluster includes three numerical sentences. Cluster scoring engine 425 may generate a score for the cluster based on the scores associated with one or more of the three numerical sentences. For example, cluster scoring engine 425 may generate a score based on a sum of the three scores, an average of the three scores, a median of the three scores, a minimum of the three scores, a maximum of the three scores, a variance of the three scores, a standard deviation of the three scores, and/or any other operation that is based on one or more of the three scores. In some implementations, cluster scoring engine 425 may generate a score based on a subset of the three scores, such as a sum of the scores in the subset, an average of the scores in the subset, a median of the scores in the subset, a minimum of the scores in the subset, a maximum of the scores in the subset, a variance of the scores in the subset, a standard deviation of the scores in the subset, and/or any other operation that is based on one or more of the scores in the subset.

In some implementations, cluster scoring engine 425 may generate a score for a cluster based on scores of fewer than all of the numerical sentences in the cluster. For example, cluster scoring engine 425 may generate a score for the cluster based on scores of up to a maximum quantity or proportion of the numerical sentences in the cluster. For example, assume that a particular cluster includes 100 answers, and that the maximum quantity of scores is 50. In such an example, cluster scoring engine 425 may generate a score for the cluster based on the 50 highest scores, the 50 lowest scores, the middle 50 scores, a random selection of 50 scores, or any other 50 of the 100 scores.

Cluster scoring engine 425 may provide information regarding the clusters, as well as the scores for the clusters, to answer selection engine 430. Answer selection engine 430 may rank the clusters according to, for example, the scores associated with the clusters. Answer selection engine 430 may identify a highest-ranking cluster, and may select a numerical sentence from the cluster. In some implementations, answer selection engine 430 may select, for example, a highest-scoring numerical sentence, out of the numerical sentences of the cluster, from the highest-ranking cluster. In some implementations, answer selection engine 430 may additionally, or alternatively, select any other numerical sentence from the highest-ranking cluster, e.g., a second-highest ranking numerical sentence, a lowest-ranking numerical sentence, a randomly selected numerical sentence, etc.

In some implementations, cluster scoring engine 425 may additionally, or alternatively, select one or more numerical sentences from one or more other clusters. For example, cluster scoring engine 425 may select a highest-scoring numerical sentence from a second-highest scoring cluster and/or a highest-scoring numerical sentence from a third-highest scoring cluster.

Answer selection engine 430 may output the selected one or more numerical sentences. That is, in some implementations, answer selection engine 430 may output a single numerical sentence or a single number as a potential answer to a query. In other implementations, answer selection engine 430 may output multiple numerical sentences or multiple numbers as potential answers to a query. In some implementations, answer selection engine 430 may merge multiple numerical sentences into a single sentence, and output the merged sentence as a potential answer to a query. Additionally, or alternatively, answer selection engine 430 may output a score associated with the one or more selected numerical sentences.

In some implementations, answer selection engine 430 may provide the selected one or more numerical sentences or numbers to a user device, such as user device 205. In some implementations, answer selection engine 430 may provide the selected one or more numerical sentences or numbers to one or more other devices, e.g. a system that aggregates candidate answers from various sources and selects an answer out of the aggregated candidate answers.

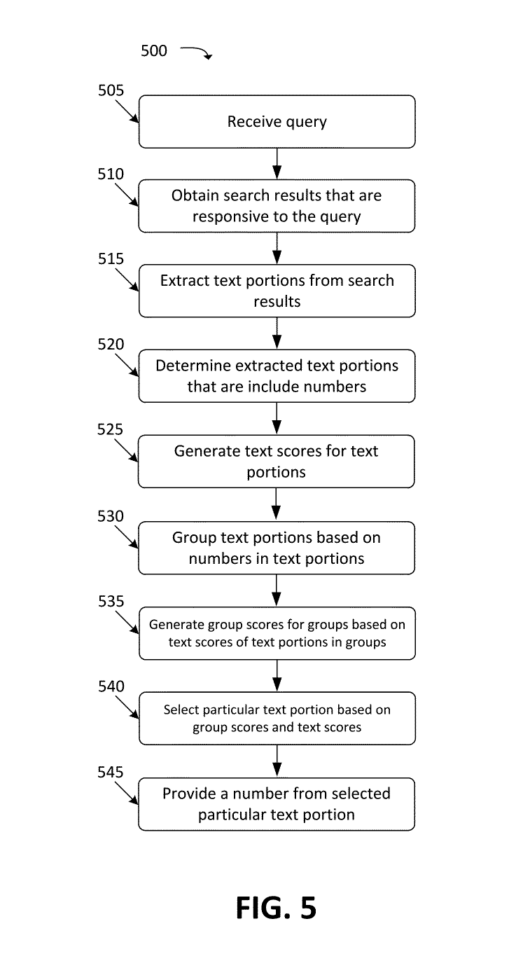

FIG. 5 illustrates a flowchart of an example process 500 for providing a numerical sentence as an answer to a query. In some implementations, process 500 may be performed by one or more components of numerical answer system 210. In some implementations, process 500 may be performed by one or more other components instead of, or possibly in conjunction with, numerical answer system 210. The process 500 will be described as being performed by a system of one or more computers, e.g. the watch time engine 160 of FIG. 1

The system receives a query (block 505). For example, numerical answer system 210 may receive a query from a user device, e.g. user device 205.

The system obtains search results that are responsive to the query (block 510). For example, as described above with respect to result identification engine 405, numerical answer system 210 may identify a search results that are responsive to the query, and/or may receive a search results that are responsive to the query from search engine server 215 and/or some other device.

The system extracts text portions from the search results (block 515). For example, as described above with respect to numerical sentence extraction engine 410, numerical answer system 210 may extract text portions from the search results identified at block 510. Furthermore, as also described above with respect to numerical sentence extraction engine 410, numerical answer system 210 may assign confidence scores to the extracted text portions that indicate a likelihood that the text portions include full independent clauses.

The system determines which extracted text portions include numbers (block 520). For example, as described above with respect to numerical sentence extraction engine 410, numerical answer system 210 may determine which extracted text portions include one or more numbers. If an extracted text portion includes both an independent clause and a number, the system can designate the text portion as a numerical sentence.

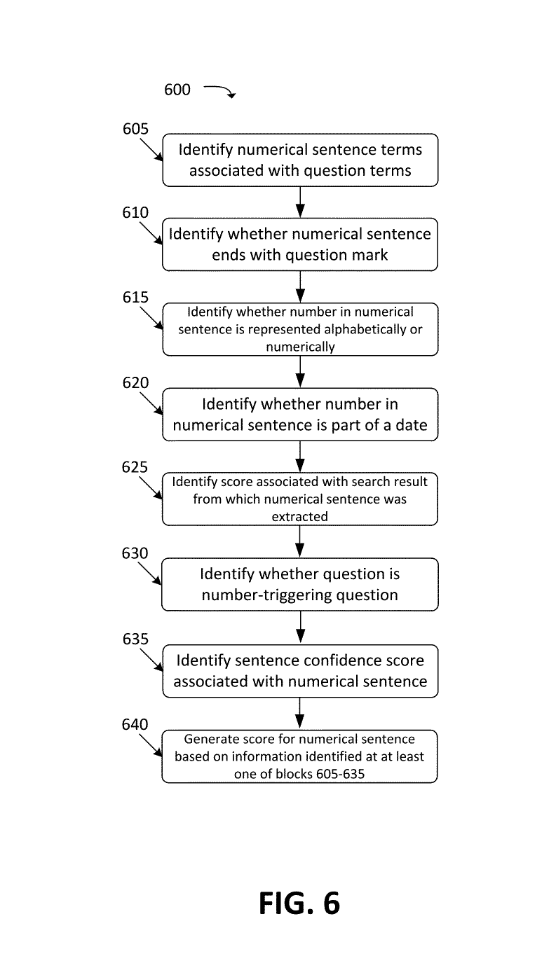

The system generates text scores for the text portions (block 525). For example, as described above with respect to numerical sentence scoring engine 415, numerical answer system 210 may generate scores for numerical sentences. An example process 600 for generating scores for text portions that are numerical sentences is described in further detail below with respect to FIG. 6.

The system groups text portions based on the numbers in the text portions (block 530). For example, as described above with respect to cluster generation engine 420, numerical answer system 210 may generate clusters that are associated with numbers and/or ranges of numbers that are found in text portions identified at block 520.

The system generates group scores for the clusters based on scores of text portions in the groups (block 535). For example, as described above with respect to cluster scoring engine 425, numerical answer system 210 may generate scores for clusters based on scores of some or all of the text portions associated with the clusters generated at block 520.

The system selects a particular text portion based on group scores and text scores (block 540). For example, as described above with respect to answer selection engine 430, numerical answer system 210 may select one or more numerical sentences, such as a highest-scoring sentence from a highest-scoring cluster, and/or one or more other numerical sentences.

The system provides a number from the selected particular text portion (block 545). For example, as described above with respect to answer selection engine 430, numerical answer system 210 may output a particular text portion or a number from a particular text portion to user device 205.

While series of blocks have been described with regard to FIG. 5, the order of the blocks may be modified in other implementations. Furthermore, non-dependent blocks may be performed in parallel. Furthermore, in some implementations, process 500 may include fewer, additional, or different blocks.

FIG. 6 illustrates a flowchart of an example process 600 for generating a score for a particular numerical sentence. As mentioned above, process 600 may correspond to block 525 of process 500. In some implementations, process 600 may be performed by one or more components of numerical answer system 210. In some implementations, process 600 may be performed by one or more other components instead of, or possibly in conjunction with, numerical answer system 210.

Process 600 may include identifying numerical sentence terms that are associated with query terms (block 605). For example, as described above with respect to numerical sentence scoring engine 415, numerical answer system 210 may identify a quantity and/or ratio of terms in the numerical sentence that are associated with terms in a query, such as the query received at block 505.

Process 600 may also include identifying whether the numerical sentence ends with a question mark (block 610). For example, as described above with respect to numerical sentence scoring engine 415, numerical answer system 210 may identify whether the numerical sentence ends with a question mark.

Process 600 may further include identifying whether a number in the numerical sentence is represented alphabetically or numerically (block 615). For example, as described above with respect to numerical sentence scoring engine 415, numerical answer system 210 may include whether a number is represented with alphabetic characters or numerical characters.

Process 600 may additionally include identifying whether a number in the numerical sentence is part of a date (block 620). For example, as described above with respect to numerical sentence scoring engine 415, numerical answer system 210 may identify whether a number in the numerical sentence is part of a date.

Process 600 may also include identifying a score associated with a search result from which the numerical sentence was extracted (block 625). For example, as described above with respect to numerical sentence scoring engine 415, numerical answer system 210 may identify a score associated with a search result from which the numerical sentence was extracted, such as a search result identified at block 510. As described above, the score may be based on any one or more of a variety of factors, such as a relevance of a document associated with the search result to the query received at block 505, a quantity of links to and/or from the document, a measure of freshness of the document, a document inception date associated with the document, an amount of advertising traffic associated with the document, and/or any other factor.

Process 600 may further include identifying whether a query, associated with the numerical sentence, is a number-triggering query (block 630). For example, as described above with respect to numerical sentence scoring engine 415, numerical answer system 210 may identify whether a query, such as the query received at block 505, is a number-triggering query. For instance, when making this identification, numerical answer system 210 may determine whether the query includes one or more terms from a list of terms associated with number-triggering queries.

Process 600 may also include identifying a sentence confidence score associated with the numerical sentence (block 635). For example, as described above with respect to numerical sentence extraction engine 410, numerical answer system 210 may identify a sentence confidence score for the numerical sentence, which may reflect a likelihood that the numerical sentence is a full sentence or a sentence fragment.

Process 600 may additionally include generating a score for the numerical sentence based on information identified at one or more of blocks 605-635 (block 640). For example, as described above with respect to numerical sentence scoring engine 415, numerical answer system 210 may generate or modify a score for the numerical sentence based on some or all of the information identified at blocks 605-635.

In some implementations, process 600 may include different, additional, or fewer blocks than those shown in the example illustrated in FIG. 6. For example, in some implementations, process 600 may omit one or more of blocks 604-635. In some such implementations, block 640 may include generating or modifying a score for the numerical sentence based on information identified at one or more, but fewer than all, of blocks 605-635.

While a series of blocks have been described with regard to FIG. 6, the order of the blocks may be modified in other implementations. Further, non-dependent blocks may be performed in parallel. Further, in some implementations, process 600 may include fewer, additional, or different blocks.

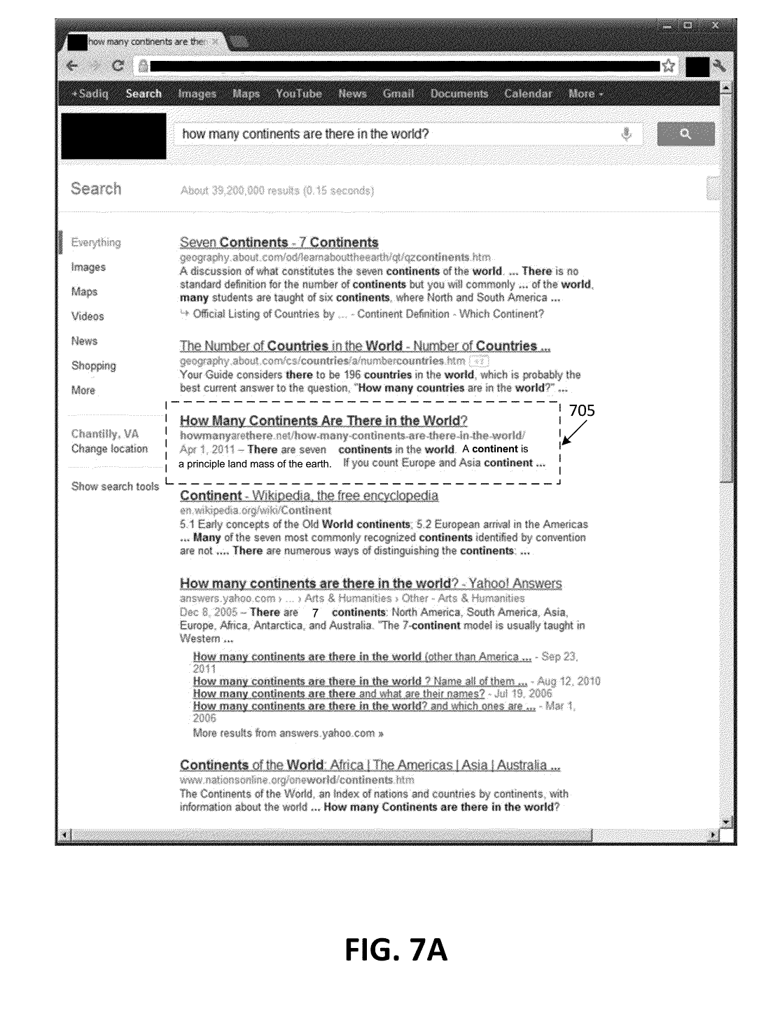

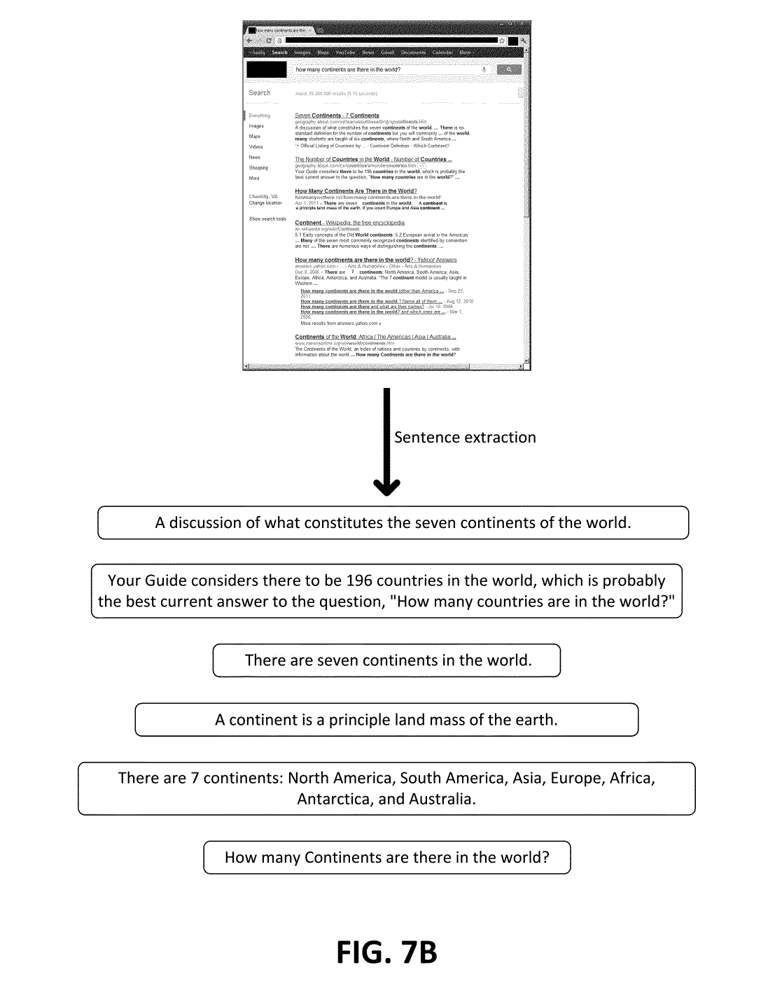

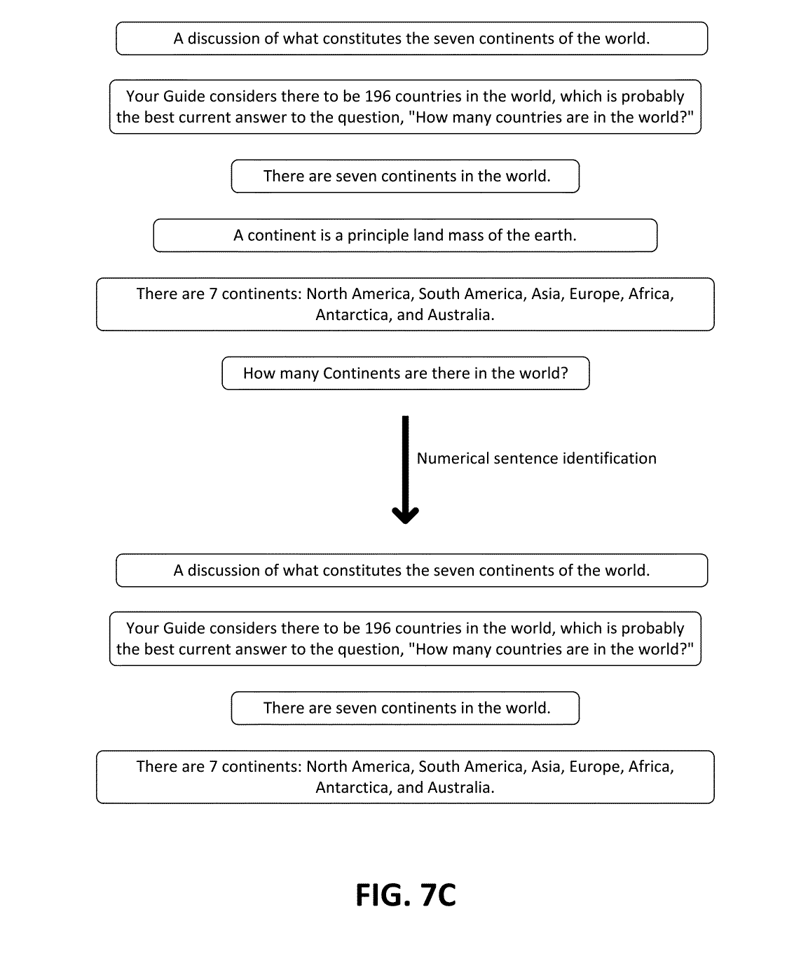

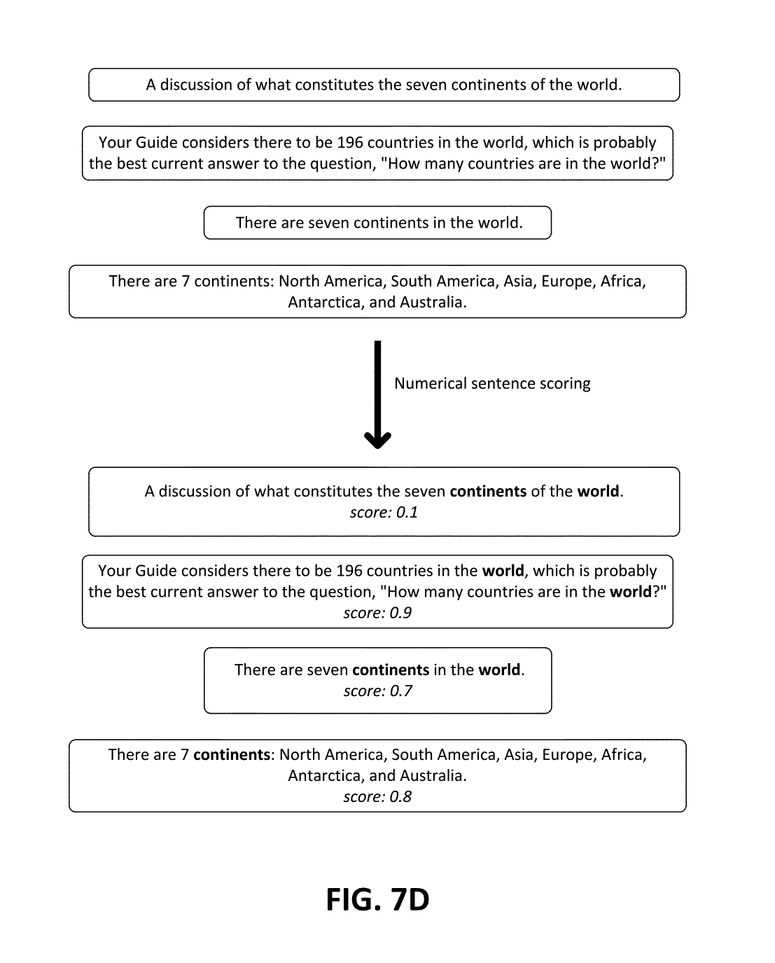

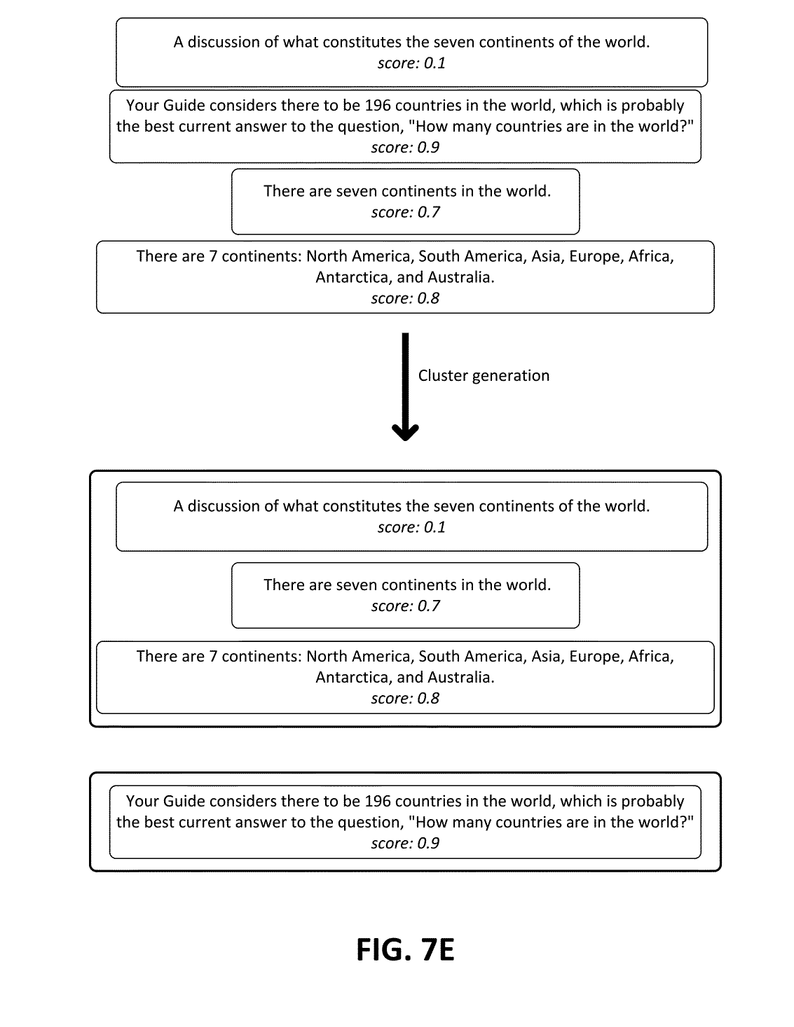

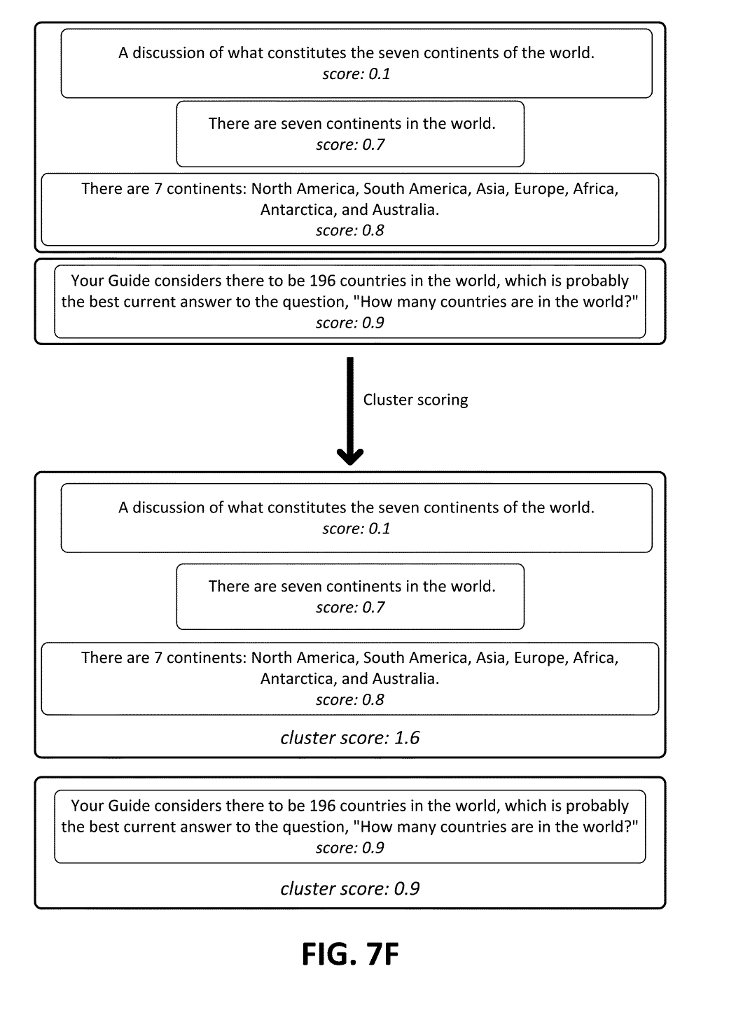

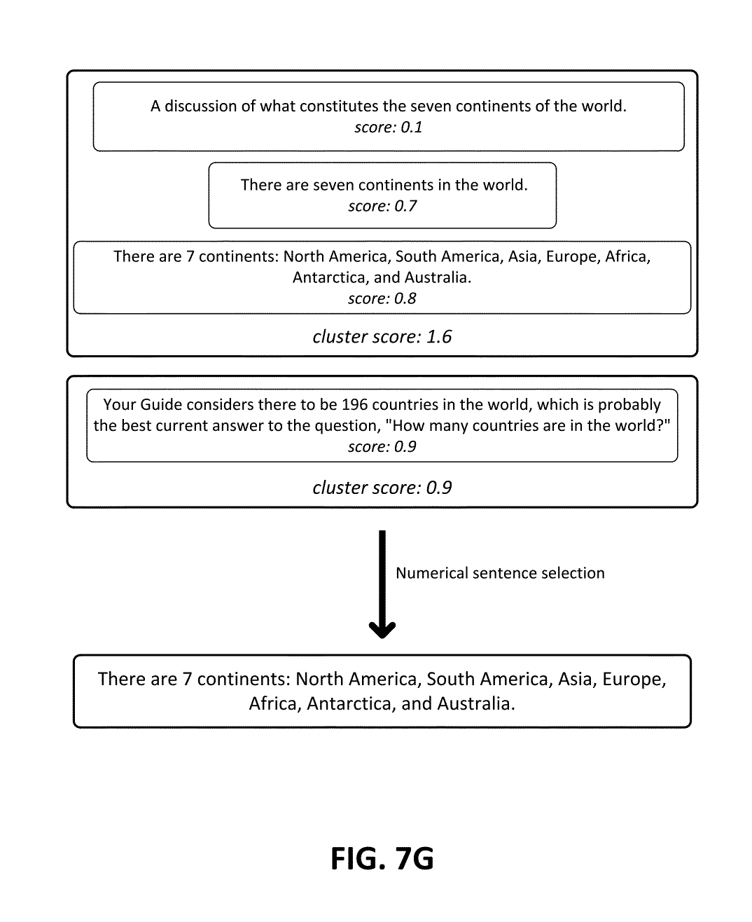

FIGS. 7A-7G illustrate an example of providing a text portion corresponding to a numerical sentence in response to a query. Referring back to the example shown in FIG. 1A, a user device, such as user device 110, may receive a query from user 105, such as “How many continents are there in the world?” A numerical search system, such as numerical answer system 210, may receive the query. Numerical answer system 210 may identify one or more search results, and/or receive information regarding one or more search results from one or more other devices, such as search engine server 215.

FIG. 7A illustrates some example search results, which may be received in response to the query “How many continents are there in the world?” As mentioned above, one or more of the search results may be associated with a snippet, which may include text derived from documents associated with the search results. For example, search result 705 may include the snippet, “There are seven continents in the world. A continent is a principle land mass of the earth. If you count Europe and Asia continent . . . . ”

FIG. 7B illustrates text portions that may be extracted from the snippets by, for example, numerical sentence extraction engine 410 of numerical answer system 210. As shown in FIG. 7B, snippets and/or portions of snippets that are not full independent clauses may not be extracted. As further described above with respect to numerical sentence extraction engine 410, these sentences may be associated with sentence confidence scores, in some implementations.

FIG. 7C illustrates numerical sentences that may be identified out of the extracted text portions by, for example, numerical sentence extraction engine 410 of numerical answer system 210. As shown in FIG. 7C, some of the extracted sentences, such as “A continent is a principal land mass of the earth” and “How many Continents are there in the world?” may be discarded, as these text portions do not include numbers.

FIG. 7D illustrates scores that may be assigned to the identified numerical sentences by, for example, numerical sentence scoring engine 415 of numerical answer system 210. As described above, these scores may be based on various factors, such as, for example, the quantity and/or ratio of numerical sentence terms associated with query terms, whether a numerical sentence ends with a question mark, whether a number is represented alphabetically or numerically, whether a number in a numerical sentence is part of a date, a score and/or associated with a search result from which the numerical sentence was extracted, a sentence confidence score associated with the numerical sentence, and/or any other factor.

For instance, numerical answer system 210 may identify that the numerical sentence “A discussion of what constitutes the seven continents of the world” is a sentence fragment, includes two terms of the query, is associated with a highest-ranking search result out of the identified numerical sentences, does not end with a question mark, includes an alphabetical representation of the number “7,” etc. As another example, numerical answer system 210 may identify that the numerical sentence “Your Guide considers there to be 196 countries in the world, which is probably the best current answer to the query, ‘How many countries are in the world?”’ is not a sentence fragment, ends with a question mark, includes a numerical representation of the number “196,” etc.

FIG. 7E illustrates clusters that may be generated based on the numerical sentences by, for example, cluster generation engine 420 of numerical answer system 210. As shown in FIG. 7E, numerical answer system 210 may generate one cluster for the number “7,” and another cluster for the number “196.” The cluster for the number “7” may include the numerical sentences “A discussion of what constitutes the seven continents of the world,” “There are seven continents in the world,” and “There are 7 continents: North America, South America, Asia, Europe, Africa, Antarctica, and Australia.” The cluster for the number “196” may include the sentence “Your Guide considers there to be 196 countries in the world, which is probably the best current answer to the query, ‘How many countries are in the world?’”

FIG. 7F illustrates scores for the clusters that may be generated by, for example, cluster scoring engine 425 of numerical answer system 210. As described above, the scores for the clusters may be based on the scores associated with one or more of the numerical sentences in the clusters. As shown in FIG. 7F, the scores for the clusters may be based on a sum of the respective scores associated with the numerical sentences in the clusters. For example, the numerical sentences in the cluster for the number “7” may be associated with scores of 0.1, 0.7, and 0.8. Thus, in this example, the score for the cluster may be 1.6, i.e., the sum of 0.1, 0.7, and 0.8. As also shown in FIG. 7F, the sole numerical sentence in the cluster for the number “196” may be associated with a score of 0.9. Thus, in this example, the score for the cluster may be 0.9.

FIG. 7G illustrates a selection of a numerical sentence by, for example, answer selection engine 430 of numerical answer system 210. Numerical answer system 210 may, for example, rank the clusters based on cluster scores, and select a highest-scoring numerical sentence from the highest-scoring cluster. As shown in FIG. 7G, numerical answer system 210 may select the sentence “There are 7 continents: North America, South America, Asia, Europe, Africa, Antarctica, and Australia,” which is the highest-scoring sentence of the highest-scoring cluster.

In this example, the selected numerical sentence is not associated with the highest score out of all of the extracted numerical sentences, as the sentence “Your Guide considers there to be 196 countries in the world, which is probably the best current answer to the query, ‘How many countries are in the world?’” is associated with a higher score, i.e., 0.9 as opposed to 0.8. However, in the example shown in FIG. 7G, numerical answer system 210 may select the numerical sentence “There are 7 continents: North America, South America, Asia, Europe, Africa, Antarctica, and Australia,” based on this sentence being associated with a higher scoring cluster than the cluster with which the sentence “Your Guide considers there to be 196 countries in the world, which is probably the best current answer to the query, ‘How many countries are in the world?’” is associated.

Numerical answer system 210 may output the selected numerical sentence to a user device and/or one or more other devices. In some implementations, numerical answer system 210 may output the score associated with the selected numerical sentence to user device 110 and/or one or more other devices. Referring back to FIG. 1C, user device 110 may output the selected numerical sentence. For example, user device 110 may audibly and/or visually output the selected numerical sentence.

Some implementations, described herein, may allow one or more devices to provide answers to queries provided by users. The one or more devices may identify numerical answers—that is, answers that include numbers—that may be related to the queries. Based on various factors described above, the one or more devices may select a numerical answer that may be a strong answer to the particular query, thus enhancing the user's experience.

The foregoing description provides illustration and description, but is not intended to be exhaustive or to limit the implementations to the precise form disclosed. Modifications and variations are possible in light of the above description or may be acquired from practice of the implementations. For example, while series of blocks have been described with regard to FIGS. 5 and 6, the order of the blocks may be modified in other implementations. Further, non-dependent blocks may be performed in parallel. Further, in some implementations, processes 500 and/or 600 may include fewer, additional, or different blocks.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computer-implemented method comprising:
receiving a query;
obtaining search results that are responsive to the query;
identifying one or more text portions each corresponding to a numerical sentence in text associated with the search results;
determining a text score for each text portion based on one or more criteria, comprising determining whether each text portion includes one or more terms that are synonyms of terms of the query;
grouping the one or more text portions by a number included in each text portion;
determining a group score for each group based on respective scores of text portions in the group;
selecting a particular text portion based on group scores of each group; and
providing a response to the query that includes a number from the particular text portion.

2. The method of claim 1, wherein selecting a particular text portion based on scores of each group comprises selecting a particular text portion having a highest text score from a particular group having a highest group score.

3. The method of claim 1, wherein identifying one or more text portions each corresponding to a numerical sentence or sentence fragment comprises determining a sentence confidence score for a text portion; and
comparing the sentence confidence score to a threshold.

4. The method of claim 3, wherein determining a sentence confidence score for a text portion includes determining whether the text portion includes a subject, a verb, and an object.

5. The method of claim 1, wherein identifying one or more text portions each corresponding to a numerical sentence or sentence fragment comprises identifying text portions that include numerical characters or alphabetically spelled numbers.

6. (canceled)

7. (canceled)

8. The method of claim 1, wherein determining a text score for each text portion based on one or more criteria includes determining a lower text score for text portions that include alphabetic numbers than text portions that include numerals.

9. The method of claim 1, wherein determining a text score for each text portion based on one or more criteria includes determining the text score based on a rank of a search result that includes the text portion.

10. The method of claim 1, wherein determining a text score for each text portion based on one or more criteria includes determining a lower text score for text portions that end with question marks than text portions that do not end in question marks.

11. The method of claim 1, wherein determining a text score for each text portion based on one or more criteria includes determining a lower text score for text portions that are sentence fragments than text portions that are full sentences.

12. A system comprising:
one or more computers and one or more storage devices storing instructions that are operable, when executed by the one or more computers, to cause the one or more computers to perform operations comprising
receiving a query;
obtaining search results that are responsive to the query;
identifying one or more text portions each corresponding to a numerical sentence in text associated with the search results;
determining a text score for each text portion based on one or more criteria, comprising determining whether each text portion includes one or more terms that are synonyms of terms of the query;
grouping the one or more text portions by a number included in each text portion;
determining a group score for each group based on respective scores of text portions in the group;
selecting a particular text portion based on group scores of each group; and
providing a response to the query that includes a number from the particular text portion.

13. The system of claim 12, wherein selecting a particular text portion based on scores of each group comprises selecting a particular text portion having a highest text score from a particular group having a highest group score.

14. The system of claim 12, wherein identifying one or more text portions each corresponding to a numerical sentence or sentence fragment comprises determining a sentence confidence score for a text portion; and
comparing the sentence confidence score to a threshold.

15. The system of claim 14, wherein determining a sentence confidence score for a text portion includes determining whether the text portion includes a subject, a verb, and an object.

16. The system of claim 12, wherein identifying one or more text portions each corresponding to a numerical sentence or sentence fragment comprises identifying text portions that include numerical characters or alphabetically spelled numbers.

17. (canceled)

18. (canceled)

19. The system of claim 12, wherein determining a text score for each text portion based on one or more criteria includes determining a lower text score for text portions that include alphabetic numbers than text portions that include numerals.

20. The system of claim 12, wherein determining a text score for each text portion based on one or more criteria includes determining the text score based on a rank of a search result that includes the text portion.

21. The system of claim 12, wherein determining a text score for each text portion based on one or more criteria includes determining a lower text score for text portions that end with question marks than text portions that do not end in question marks.

22. The system of claim 12, wherein determining a text score for each text portion based on one or more criteria includes determining a lower text score for text portions that are sentence fragments than text portions that are full sentences.

23. A computer program product, encoded on one or more non-transitory computer storage media, comprising instructions that when executed by one or more computers cause the one or more computers to perform operations comprising:
receiving a query;
obtaining search results that are responsive to the query;
identifying one or more text portions each corresponding to a numerical in text associated with the search results;
determining a text score for each text portion based on one or more criteria, comprising determining whether each text portion includes one or more terms that match or are synonyms of terms of the query;
grouping the one or more text portions by a number included in each text portion;
determining a group score for each group based on respective scores of text portions in the group;
selecting a particular text portion based on group scores of each group; and
providing a response to the query that includes a number from the particular text portion.
